(19) United States
(12) Patent Application Publication
(10) Pub. No.: US 2005/0255916 A1
(43) Pub. Date: Nov. 17, 2005

(54) Adaptable game controller

(76) Inventor: Paul Chen, Los Angeles, CA (US)

Correspondence Address: BRUCE A. JAGGER, 6100 CENTER DRIVE, SUITE 630, LOS ANGELES, CA, 90045, US

(21) Appl. No.: 10/844,947

(22) Filed: May 12, 2004

(51) Int. Cl. A63F 13/00

(52) U.S. Cl. 463/37

(57) ABSTRACT

A smart game controller faceplate is disclosed that has a graphic on its front representative of a computer or video game with which it is used. The faceplate connects electronically to a game controller when the faceplate is removably and replaceably attached to the game controller. The face plate has graphic on the front of it that is representative of the game. The face plate communicates electronically with the game controller. This electronic communication modifies the playing of the game. When the electronic communication is enabled by a chip, the chip has software coding that enhances the performance of the game of which the graphic on the front is representative. Several games are provided, and each game has a specific face plate associated therewith. The enhancements provided by the face plate are specific to the game with which ir is associated.

### FIELD OF THE INVENTION

The present invention relates to computer and video games, and more particularly it relates to a system and method to enhance their function.

### BACKGROUND OF THE INVENTION

Computer and video games have developed along with the computer revolution. Each new enhancement of the functionality of the computers has been translated into additional enhancements of the functionality of computer and video games. A number of systems are currently available to the computer gamer (i.e. those who like to play computer and video games). Among the available systems are the Sony Playstation, the Microsoft X-Box, the Nintendo Gamecube, PC computer and Apple computer. These are in addition to games that can be played on the standard computer. Additionally, there are other systems commercially available.

FIG. 1 is a block type diagram of one computer game set up. The system includes computer 21 a display 23 and a game controller 25. Computer 21 can be a standard IBM type of computer or an Apple Computer. Display 23 can be a CRT, LCD or plasma screen display. Game controller 25 is typically a hand held device that connects to the computer and allows the user to control functions of the computer such as movement of a figure on the screen, etc. Game controllers include joysticks and a wide variety of handheld devices that include knobs, dials and buttons that provide a wide variety of functionality. The game itself is generally enabled by software, not shown, which can be loaded onto the computer in the typical fashion from a floppy disk, CD, or downloading over the internet from a website.

Another variation of the typical computer game system is depicted in FIG. 2 a block type diagram of the major functional components. The system includes computer 21, display 23, game controller 25, and base control unit 27. Base control unit 27 connects game controller 25 to computer 21. Base control unit contains either software or hardwired game instructions that run on the computer. Games that are played on the system typically are on a game module 26. Game module 26 has the game in software on a memory chip, not shown, in module 26. Module 26 plugs into a slot 28 on base unit, which reads the software code and allows the game to be played on the computer.

In an additional variation, there may be an entire independently operating base unit 29 [FIG. 3] which has game controller 25 attached to it. Operating base unit 29 also attaches to a display of 31. Display 31 could be a television, a CRT screen, LCD screen, or plasma screen or any similar type of device. Typically, with this type of set up the games enabled on base unit 29 are also contained in modules 35 that contain appropriate memory media in which the game instructions are stored and downloaded when the game module 35 is plugged into base unit 29. Here again, the user controls activity on the screen with game controller 25, such as the joystick or other handheld control apparatuses with various buttons and other enabling devices.

A wide variety of games can be played using the computer or video game systems currently available. In fact the number of games is only limited by the creativity of the game writers. As noted, the different games are provided either in the form of software downloadable to the computer or on game modules that plug into a base unit and have the appropriate software that enables the game. A few of the widely available games are Tomb Raider, Grand Theft Auto, or ATV Offroad, etc. For example, in a game like Grand Theft Auto, one of the participants takes the role of a car thief and the other takes the role of a police officer chasing a car thief, assuming two persons are playing the game. Alternatively, one can play against the computer by taking one of the roles and letting software programmed into the system simulate the other participant. The game involves a mock automobile chase. The player controls operation of the automobile on the screen with the game controller.

One of the keys to the success in the electronic gaming industry is to provide video and computer games that are new and unique and catch the fancy of computer gamers. One of the means used to catch the fancy of the gaming public is to have different features that only become apparent to the user during use. When initially developing games, developers embed “backdoors” into the games that are not readily apparent or listed in the games instructions on release. In part this may be due to the fact that it requires several different keystrokes or special moves. At some point after release of the game to the public the backdoors are disclosed to the public. This helps prolong interest in the game and extend its profitable commercial life. The back doors add additional functionality to the game by allowing the user to do additional things when playing the game. These include skipping levels or adding functionality or add actions to the character not readily apparent due to the complexity of the keystrokes necessary or some other action required to enable them when the game is originally released.

Additionally the typical computer game has a graphic art theme, i.e. images of the starring characters in the game or other theme of the game to appeal to the users of the game. In fact the sales of posters and other artwork related to the graphic seen on the particular game is an auxiliary or side market related to the sale of the game. Typically, the game controller is designed to accept faceplates. Each game that can be played on the system generally has its own faceplate with graphic art with the theme of the game that is being played. This artwork may include the central characters of the game or some other appropriate artwork. Thus, the game player can change the faceplate with each game played.

One of the problems with the current system is that in order to take advantage of the back doors or other enhancements one must learn complicated and arbitrary keystrokes that detract from enjoyment of the game. An additional disadvantage is that one must go to a special website to obtain this information.

### SUMMARY

It is an objective of the present invention to provide a device to enhance the functionality of a computer or video game. It is a further objective to provide a system and method that is easy to implement and enhances the enjoyment of the experience for the gamer.

These and other advantages are provided by providing a game controller having: a) a game controller configured to function with a multifunctional game system, the system capable of playing a plurality of different games and the game controller allowing for control of functions of a game being played on the system; b) the game controller being adapted to receive a face plate with a graphic representation of a specific game being played; and c) the face plate containing electronic signal capability to enhance the function of the game controller and operation of a specific game being played on the game system.

In another aspect of the invention it provides a game controller faceplate having: a) a faceplate configured to detachably fit over the top of a game controller such that activation and manipulation devices on the game controller are accessible by a user of the game controller when being used with the faceplate attached; b) the faceplate having a graphic on its top that has a relation to a game being played with the game controller while the face plate is attached to the game controller; and c) the faceplate incorporating a chip with information in an electronic format for enhancement of the functioning of a game being played with the game controller and the faceplate is attached to the game controller.

In yet another aspect of the invention it provides a method for enhancing the functionality of an electronic game with the steps of: a) providing a game played on an electronic video system; b) controlling action of the game with a game controller; c) providing a detachable faceplate for the game controller that includes graphic art work on its front with a relation to the game; and d) enhancing the functionality of the game by embedding a device in the rear of the faceplate that electronically connects to the game controller when it is attached to the game controller.

### BRIEF DESCRIPTION OF THE DRAWINGS

The invention will be better understood by an examination of the following description, together with the accompanying drawings, in which:

FIG. 1 a block diagram of one variation of a system that would employ the present invention;

FIG. 2 a block diagram of a second variation of a system that would employ the present invention;

FIG. 3 a block diagram of a third variation of a system that would employ the present invention;

FIG. 4 a top view of a game controller that would employ the present invention;

FIG. 4A is a cross-sectional view along line IVA-IVA of FIG. 4;

FIG. 5 a view of the front of the controller depicted in FIG. 4;

FIG. 6 a top view of a faceplate of the present invention;

FIG. 6A is a cross-sectional view along line VIA-VIA of FIG. 6;

FIG. 7 a top view of a controller on which the faceplate of FIG. 6 has been secured;

FIG. 8 a bottom view of a faceplate of FIG. 6;

FIG. 9 a flow-chart depicting one implementation the functionality of the present invention when attached to a game controller; and

FIGS. 10a, 10b and 10c are a view of another variation of the present invention.

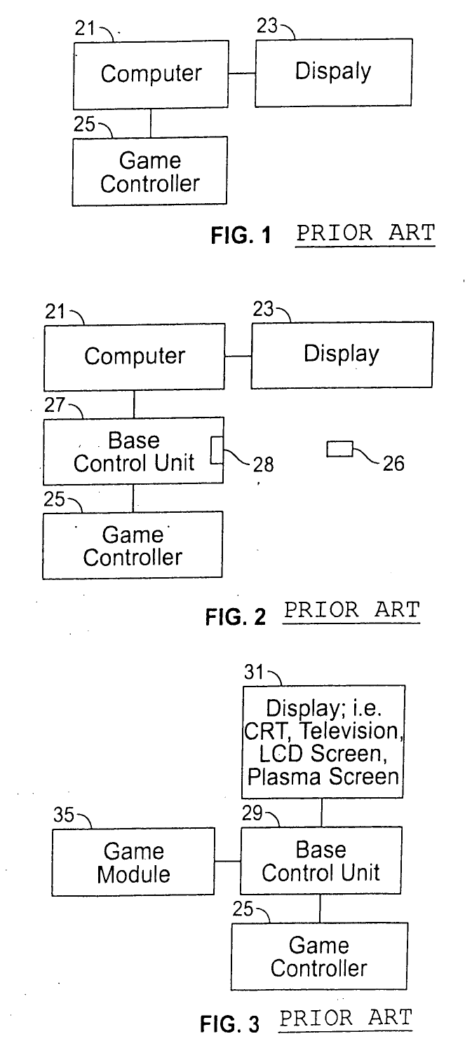

### DETAILED DESCRIPTION OF A PREFERRED EMBODIMENT

The present invention provides the concept of a faceplate for a game controller that has a thematic graphical representation of a particular game that can be played with the game controller plus features to enhance the functionality of the game. In one variation of the preferred embodiment the feature that enhances the game is a computer chip with appropriate software that when connected to the game controller adds certain enhancements to the functionality of the game that will be played.

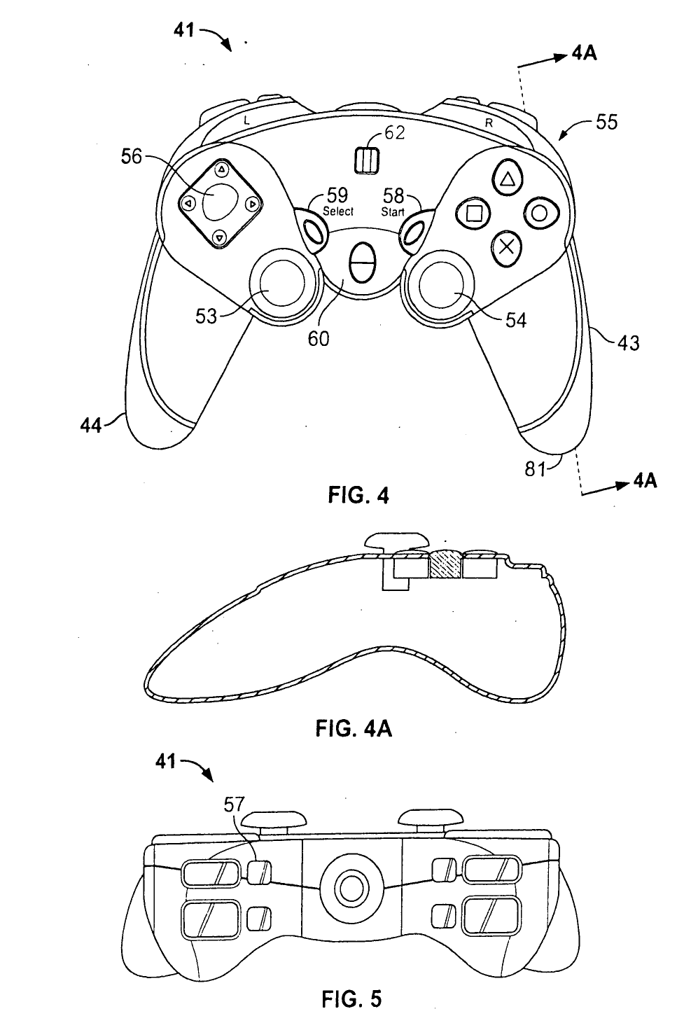

FIG. 4 provides a top view of a typical computer game controller 41. Game controller 41 has handles, 43 and 44, which are held respectively by the right and left hand of the game player. Additionally, thumb knobs 53 and 54 are placed within reach of the users thumbs while they are holding game control 41. This allows the user to control action on the screen. Game controller 41 also includes additional buttons 55 and a digital pad 56 to add additional functionality and control. In the variation of the controller depicted in FIG. 4 controller 41 turns on when it is electrically connected to a computer or base control unit that is turned on. Button 58 activates the start of the game and during playing of the game can have selective functionality, such as pausing the game, etc. Button 59 allows you to make a selection of a variation of a game to play and button 60 is an analog switch that can have any number of functions. Additionally, the front face of controller 41 (FIG. 5) has a number of buttons that enable various functions. Among these are buttons 57 that enables tricks. The function of the buttons, keys and knobs varies from controller to controller but generally are well known to those of ordinary skill in the art so a detailed discussion of the same is not necessary.

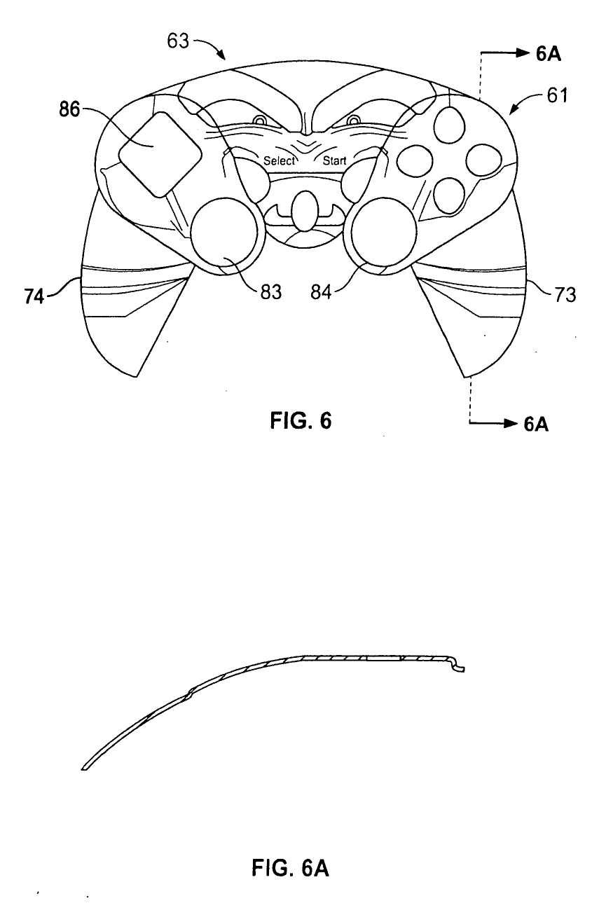

FIG. 6 is a top view of a faceplate 61 of the present invention. Faceplate 61 in essence is a cover that fits over the top of game controller 41. Faceplate 61 has the general outline of game controller 41. Additionally, faceplate 61 follows the general contours of the top of game controller 41. This aspect is illustrated by a comparison of FIG. 4A and FIG. 6A. FIG. 4A is cross-sectional profile view of game controller 41 along line IVA-IVA of FIG. 4A and FIG. 6A is a cross-sectional view of faceplate 61 along line VIA-VIA of FIG. 6A. As can be seen from this comparison faceplate 61 is essentially a shell that fits over the top of game controller 41.

Referring back to FIG. 6, faceplate 61 has portions 73 and 74 that cover the handles 43 and 44 (FIG. 4) respectively. The rest of faceplate 61 covers the rest of the body of game controller 41. Additionally, various apertures 83, 84, 61 and 86 appear on top through which the buttons controller 41, FIG. 4 can be accessed.

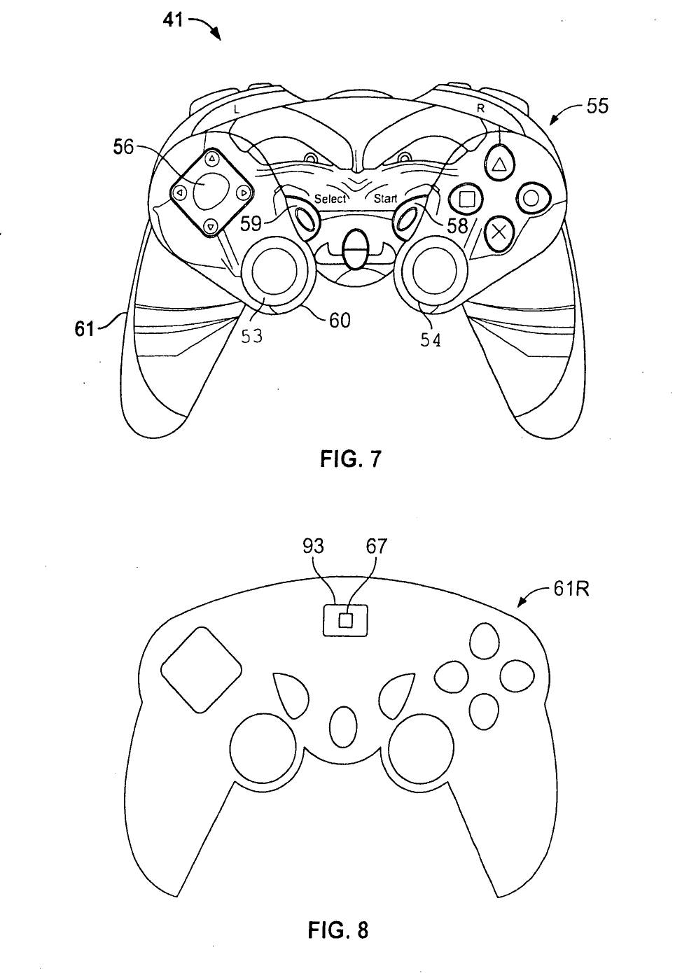

FIG. 7 provides a view of the game controller 41 with faceplate 61 attached to it. All of the knobs, buttons and control pads of game controller 61 project through the various apertures of face plate 61. Digital pad 56 projects through aperture 86, knobs 53 and 54 project through apertures 83 and 84 respectively. The same is true for the other buttons on top of controller 41.

As can be seen, the faceplate 61 has graphic art representation 63 on the top, which is representative of the game being played. For each game that can be played with the game system that game controller 41 works with there will be at least one faceplate with a theme related to the game being played. With a typical game there might be several faceplates with different graphic art works on them. These graphic art works will generally be of the different characters that one can use when playing the game. The graphic art works can also be representative of various scenes or themes from the game.

Referring back to FIG. 4, a connector 59 appears. Connector 59 is designed to detachably receive and electrically connect chip 67 that is embedded in the bottom of faceplate 61 (FIG. 8). FIG. 8 is a view of the bottom of faceplate 61. Chip 67 appears on the bottom of faceplate 67 and includes electrical connector 93 that is designed to detachably connect to connector 59 on game controller 41.

Chip 67 in one preferred embodiment is a standard memory chip with software code that adds game enhancing functionality. Chip 67 can be any number of different chips including a ROM chip (read only memory). The software code will contain instructions that will be incorporated into the game being played. Among them will be enablement of single keystrokes to replace the several keystrokes that may have originally been necessary to utilize the backdoors. The chip also could contain a Listing of the various backdoors or cheats and the keystroke or strokes necessary to activate them. Also, very difficult special moves, which require a Long and difficult sequence of keystrokes, would be pre-programmed into chip 67 for activation by one or a few keystrokes and give the user an added advantage. The long and difficult special sequences of keystrokes needed to activate the special moves are typically called Macro's. Thus, one can see that reducing and simplifying the keystrokes needed to activate the Macro's adds functionality and increases the enjoyment of the game player.

Each different faceplate will have a chip with software coding that will enhance the game to which the graphic artwork on that faceplate relates. For instance in for the computer game Dragonball Z™ a face plates for the various characters can be provided. For example the face plate could depict the character Goku of the Dragonball Z™ game. Another example would be game specific faceplates. For instance Ninia Gaiden faceplate would have depictions of scenes from the game or characters. Additionally, the faceplate would have a chip 67 that would enable secret backdoors and/or power up macros which would allow the characters to heal, increase weapons, have invulnerability, allow the characters to pass difficult levels. This would allow the typical gamer to have full enjoyment of the game. The number of characters or game themes that could be depicted to numerous to itemize here. Additionally, the number of functional enhancements that chips 67 embedded in faceplate 41 could add is is too numerous to itemize here. However, those of ordinary skill in the art, once they read this specification and understand the principles of the invention, will readily see its applicability to all kinds of computer games.

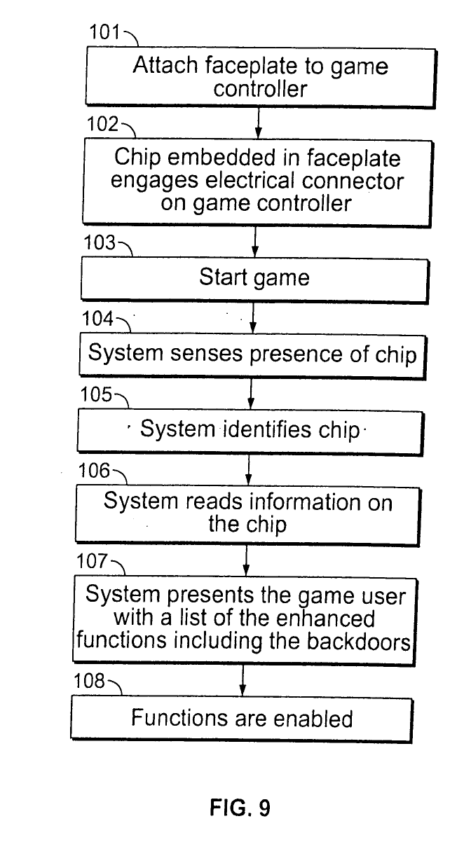

FIG. 9 presents a flow chart of one way the system would activate the functioning of the present invention. First, the player would attach the faceplate 101. Upon attaching the faceplate the chip would engage electrical contact on the games controller 102. Then the game would be started 103. Once the game is started, the system would sense the presence of the chip 104. Then the system would identify the chip 105. The system would then read the information on the chip 106. The system would then present the user with a List of functions, i.e., backdoors and other enabling features provided by the chip, as well as the keys that enable them 107. Finally, the functions would be enabled 108. As the user plays the game the user would be able to access and use the functions by use of the appropriate buttons, pads or knobs on the game controller.

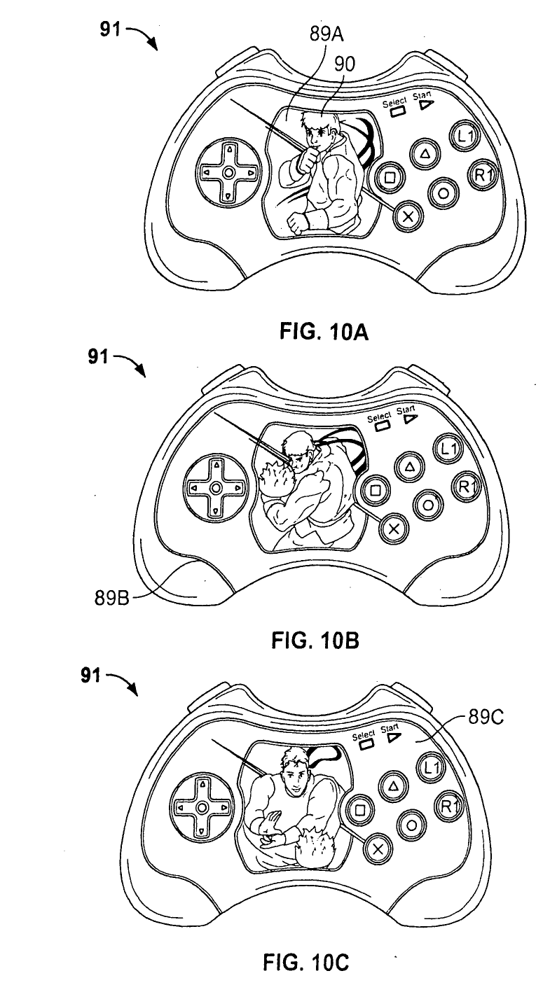

FIGS. 10a, 10b and 10c provide a view of a lenticular hologram 89 on faceplate 91. An image in the form of a Lenticular hologram is an image that appears to move as one moves the object on which it is placed. In FIGS. 10a, 10b and 10c the action character 90, Ryu owned by a Capcon, is depicted in the form of a lenticular image. In FIG. 10a image 89A provides a side view of action character 90 with fists raised. In FIG. 10B image 89B has action FIG. 90 holding a ball of fire. In FIG. 10c image 89C has action FIG. 90 throwing the ball of fire. Thus, as some one plays the game using a controller with the lenticular hologram on it FIG. 90 appears to be throwing a ball of fire. The preceding is just one example of a lenticular holographic image. Naturally, lenticular holographic images can be made of any characters from a computer game. In another variation of the invention the lenticular hologram could be directly placed on a game controller instead of on an interchangeable faceplate.

Lenticular holograms are typically limited to a few moves of the character depicted, generally three. However, in another variation of the game a holographic image could be embedded in the changeable faceplate. Naturally, the holographic image would be imbedded in an appropriate material of appropriate thickness, well known in the art, which would allow the figure or scene to be three dimensional in format.

While the invention has been particularly shown and described with reference to a preferred embodiment thereof, it will be understood by those skilled in the art that various changes in form and detail may be made to it without departing from the spirit and scope of the invention.

1-31. (canceled)

32. A game controller configured to function with a multifunctional game system, said game system being capable of playing a plurality of different games and said game controller being capable of controlling the play of each of said plurality of different games, wherein the improvement comprises:
a face plate configured to being removably and replaceably mounted to said game controller in electronic communication with said controller, said face plate being especially adapted for use with a specific one of said plurality of different games.

33. A game controller of claim 32 including a plurality of said face plates each of which is especially adapted for use with a different said specific one.

34. A game controller of claim 32 wherein said face plate includes an electronic chip that enables said electronic communication.

35. A game controller of claim 34 wherein said electronic chip is a ROM chip.

36. A game controller of claim 32 including a graphic representation associated with said specific one.

37. A game controller of claim 36 wherein said graphic representation comprises a lenticular hologram.

38. A game controller of claim 32 wherein said face plate is adapted to change the capability of said game controller in controlling the play of said specific one.

39. A game controller configured to function with a multifunctional game system, said game system being capable of playing a plurality of different games and said game controller being capable of controlling the play of each of said plurality of different games, wherein the improvement comprises:
a plurality of face plates each configured to being removably and replaceably mounted to said game controller in electronic communication with said controller, each said face plate being especially adapted for use with a specific one of said plurality of different games, and each of said face plates being adapted to changing the capability of said game controller in controlling the play of said specific one.

40. A game controller of claim 39 wherein said face plate includes an electronic chip adapted to enabling said face plate to change said capability.

41. A method of modifying the functionality of an electronic game including selecting a said electronic game that is adapted to being played on an electronic video system, providing a game controller that is adapted to controlling the play of said electronic game, wherein the improvement comprises:
applying an electronically enabled removable and replaceable face plate to said game controller;
establishing electronic communication between said game controller and said face plate; and
allowing said face plate to modify said functionality through said electronic communication.

42. A method of claim 41 including providing a plurality of said electronic games and a plurality of said face plates, and permitting each of said face plates to modify the functionality of a specific one of said electronic games.

43. A game controller face plate comprising:
a face plate configured to removably and replaceably mount on a game controller; and
electronic signal capability included in said faceplate and adapted to communicating an electronic signal to said game controller and enhancing the experience of playing a game with said game controller when said face plate is so fitted mounted.

44. A game controller of claim 43 wherein said face plate includes a graphic that is indicative of said game.

45. A game controller of claim 43 wherein said electronic signal capability comprises a chip.

46. A game controller of claim 43 wherein said electronic signal capability comprises a ROM chip.
